(19) United States
(12) Patent Application Publication
(10) Pub. No.: US 2005/0159327 A1
(43) Pub. Date: Jul. 21, 2005

(54) Organic catalyst system

(75) Inventor: Gregory Scot Miracle, Hamilton, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/999,652

(22) Filed: Nov. 30, 2004

Related U.S. Application Data
(60) Provisional application No. 60/537,068, filed on Jan. 16, 2004.

(51) Int. Cl. C11D 1/00

(52) U.S. Cl. 510/311

(57) ABSTRACT

This invention relates to organic catalyst systems, cleaning compositions comprising such systems; and processes for making and using such systems and cleaning products. Such compositions employ a bleach activator having a relatively long acyl moiety.

### CROSS-REFERENCES TO RELATED APPLICATIONS

This application claims priority under 35 U.S.C. § 119(e) to U.S. Provisional Application Ser. No. 60/537, 068 filed Jan. 16, 2004.

### FIELD OF INVENTION

This invention relates to organic catalyst systems, cleaning compositions comprising such systems; and processes for making and using such systems and cleaning products.

### BACKGROUND OF THE INVENTION

Bleach activators are typically used to facilitate the removal of stains and soils from clothing and various surfaces as well as to prohibit dye transfer. It is known that the benefits obtained from bleach activators, oxygen transfer catalysts and sources of hydrogen peroxide can be optimized by introducing the oxygen transfer catalyst after the introduction of the bleach activator and the source of hydrogen peroxide. See WO 01/016263 A2. Unfortunately certain bleach activators are ineffective when used in this manner as the bleaching action of solutions containing such activators is unacceptable.

In an effort to obtain the desired performance, activators having relatively short acyl moieties such as N,N,N′,N′-tetraacetylethylene diamine and sodium 4-nonanoyloxybenzenesulfonate have been developed. While such materials may provide the desired performance, they do not offer the raw material feedstock and finished cleaning product formulation flexibility that is critical to meeting the cost and performance requirements of the end user.

Accordingly, there is a need for an organic catalyst system that can provide the required flexibility.

### SUMMARY OF THE INVENTION

The present invention relates to organic catalyst systems that comprise an organic catalyst, a bleach activator and a source of hydrogen peroxide. The present invention also relates to cleaning compositions comprising said systems and processes for making and using the aforementioned systems and cleaning compositions.

### DETAILED DESCRIPTION OF THE INVENTION

Definitions

As used herein, the term “cleaning composition” includes, unless otherwise indicated, granular or powder-form all-purpose or “heavy-duty” washing agents, especially laundry detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, laundry bars, mouthwashes, denture cleaners, car or carpet shampoos, bathroom cleaners; hair shampoos and hair-rinses; shower gels and foam baths and metal cleaners; as well as cleaning auxiliaries such as bleach additives and “stain-stick” or pre-treat types.

As used herein, the phrase “is independently selected from the group consisting of . . . ” means that moieties or elements that are selected from the referenced Markush group can be the same, can be different or any mixture of elements as indicated in the following example:

A molecule having 3 R groups wherein each R group is independently selected from the group consisting of A, B and C. Here the three R groups may be: AAA, BBB, CCC, AAB, AAC, BBA, BBC, CCA, CCB, ABC.

As used herein, “substituted” means that the organic composition or radical to which the term is applied is:
(a) made unsaturated by the elimination of elements or radical; or
(b) at least one hydrogen in the compound or radical is replaced with a moiety containing one or more (i) carbon, (ii) oxygen, (iii) sulfur, (iv) nitrogen or (v) halogen atoms; or
(c) both (a) and (b).
   Moieties which may replace hydrogen as described in (b) immediately above, that contain only carbon and hydrogen atoms are hydrocarbon moieties including, but not limited to, alkyl, alkenyl, alkynyl, alkyldienyl, cycloalkyl, phenyl, alkyl phenyl, naphthyl, anthryl, phenanthryl, fluoryl, steroid groups, and combinations of these groups with each other and with polyvalent hydrocarbon groups such as alkylene, alkylidene and alkylidyne groups. Moieties containing oxygen atoms that may replace hydrogen as described in (b) immediately above include, but are not limited to, hydroxy, acyl or keto, ether, epoxy, carboxy, and ester containing groups. Moieties containing sulfur atoms that may replace hydrogen as described in (b) immediately above include, but are not limited to, the sulfur-containing acids and acid ester groups, thioether groups, mercapto groups and thioketo groups. Moieties containing nitrogen atoms that may replace hydrogen as described in (b) immediately above include, but are not limited to, amino groups, the nitro group, azo groups, ammonium groups, amide groups, azido groups, isocyanate groups, cyano groups and nitrile groups. Moieties containing halogen atoms that may replace hydrogen as described in (b) immediately above include chloro, bromo, fluoro, iodo groups and any of the moieties previously described where a hydrogen or a pendant alkyl group is substituted by a halo group to form a stable substituted moiety.

It is understood that any of the above moieties (b)(i) through (b)(v) can be substituted into each other in either a monovalent substitution or by loss of hydrogen in a polyvalent substitution to form another monovalent moiety that can replace hydrogen in the organic compound or radical.

As used herein, the articles a and an when used in a claim, are understood to mean one or more of the material that is claimed or described.

Unless otherwise noted, all component or composition levels are in reference to the active level of that component or composition, and are exclusive of impurities, for example, residual solvents or by-products, which may be present in commercially available sources.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited are, in relevant part, incorporated herein by reference; the citation of any document is not to be construed as an admission that it is prior art with respect to the present invention.

Organic Catalyst System

Certain bleach activators, such as sodium 4-(alkanoyloxy)benzenesulfonates, perhydrolyze in the presence of alkaline peroxide to yield peracids that can participate in bleaching reactions. When the alkanoyl group reaches a certain length, perhydrolysis of the activator is inefficient. While not being bound by theory, Applicants believe this is due to the fact that the peracid anion, once formed, is a nucleophile that competes with the hydroperoxl anion for the remaining activator. Thus, the longer the alkanoyl group, the more likely both the activator and the initially formed peracid will reside together in a micelle. Under such conditions, the peracid anion has a distinct advantage over the hydroperoxyl anion since the latter will reside predominantly in the bulk solution. Accordingly, the peracid anion reacts with the remaining bleach activator to form a diacyl peroxide. Thus under such conditions diacyl peroxides, which contribute little to overall bleaching performance, constitute a significant fraction of the reaction product of perhydrolysis of certain long chain activators.

Applicants have surprisingly found that when such inefficient bleach activators are in the presence of certain organic catalysts and a source of hydrogen peroxide, bleaching performance is markedly improved. The aforementioned improved bleaching performance can be obtained from systems comprising a source of hydrogen peroxide; a bleach activator having the general formula: 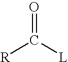
wherein R is a substituted or unsubstituted, linear or branched hydrocarbyl group containing from about 10 to about 18 carbon atoms wherein the longest linear alkyl chain extending from and including the carbonyl carbon contains greater than 10 carbon atoms and L is a leaving group, the conjugate acid of which (LH) has a pKₐ in the range of from about 4 to about 18; and an oxygen transfer catalyst selected from the group consisting of: iminium cations and polyions; iminium zwitterions; modified amines; modified amine oxides; N-sulfonyl imines; N-phosphonyl imines; N-acyl imines; thiadiazole dioxides; perfluoroimines; and mixtures thereof.

In another aspect of Applicant's invention the aforementioned bleach activator has a leaving group, the conjugate acid of which has a pKₐ in the range of from about 6 to about 13.

In one aspect of Applicant's invention said bleach activator's leaving group L has the formula: 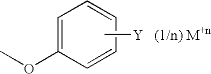
wherein Y is selected from the group consisting of —SO₃⁻ and —CO₂⁻ and M is selected from H, Li, Na, K, Mg and Ca, and n is 1 or 2

Suitable sources of hydrogen peroxide include, but are not limited to, compounds selected from the group consisting of perborate compounds, percarbonate compounds, perphosphate compounds and mixtures thereof.

Suitable bleach activators include, but are not limited to, sodium 4-(10-undecenoyloxy)benzenesulfonate, prepared as described in EP 0 733701 A1 (see, for example, page 13, Example 1); sodium 4-(lauroyloxy)benzenesulfonate, prepared as described in U.S. Pat. No. 6,448,430 B1 (see, for example, Column 9, Example 6); sodium 4-(myristoyloxy)benzenesulfonate, and sodium 4-(palmitoyloxy)benzenesulfonate, both prepared as described in JP 08053405 A2; and sodium 4-(lauroyloxy)benzoate, prepared as described in JP 08188552 A2.

Suitable oxygen transfer catalysts include, but are not limited to, oxygen transfer catalysts selected from the group consisting of: iminium cations and polyions; iminium zwitterions; modified amines; modified amine oxides; N-sulfonyl imines; N-phosphonyl imines; N-acyl imines; thiadiazole dioxides; perfluoroimines; and mixtures thereof.

In one aspect of Applicant's invention, suitable iminium cations and polyions include, but are not limited to, iminium cations and polyions having a net charge, in the absence of suitable charge balancing counterions, of from about +3 to about −3 and having a structure according to Formula I below: 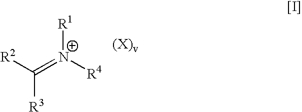
where R² and R³ are independently H or a C₁-C₃₀ substituted or unsubstituted, saturated or unsaturated radical selected from the group consisting of alkyl, cycloalkyl, aryl, alkaryl, aralkyl, heterocyclic ring, silyl, nitro, halo, cyano, sulfonato, alkoxy, keto, carboxylic, and carboalkoxy radicals; R¹ and R⁴ are independently H or a C₁-C₃₀ substituted or unsubstituted, saturated or unsaturated radical selected from the group consisting of H, alkyl, cycloalkyl, aryl, alkaryl, aralkyl, heterocyclic ring, silyl, nitro, halo, cyano, alkoxy, keto and carboalkoxy radicals; R¹ with R², R² with R³, R³ with R⁴, and R⁴ with R¹ may respectively together form a cycloalkyl, polycyclo, heterocyclic or aromatic ring system; and X is a suitable charge-balancing counterion, in one aspect of Applicant's invention X is a charge-balancing bleach-compatible counterion; and v is an integer from 1 to 3.

In one aspect of Applicant's invention, the aforementioned iminium cations and polyions have the more specific formula depicted by Formula II below: 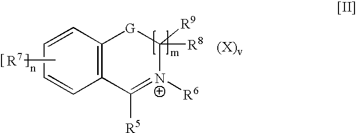
where the index m is 1 to 3 when G is present and m is 1 to 4 when G is not present; and the index n is an integer from 0 to 4; each R⁷ is independently selected from a substituted or unsubstituted radical selected from the group consisting of alkyl, cycloalkyl, aryl, fused aryl, heterocyclic ring, fused heterocyclic ring, nitro, halo, cyano, sulfonato, alkoxy, keto, carboxylic, and carboalkoxy radicals, and any two vicinal R⁷ substituents may combine to form a fused aryl, fused carbocyclic or fused heterocyclic ring; R⁵ may be a substituted or unsubstituted radical selected from the group consisting of H, alkyl, cycloalkyl, alkaryl, aryl, aralkyl, heterocyclic ring, silyl, nitro, halo, cyano, sulfonato, alkoxy, keto, carboxylic, and carboalkoxy radicals; R⁶ is a radical selected from the group consisting of substituted or unsubstituted, saturated or unsaturated, H, alkyl, cycloalkyl, alkaryl, aryl, aralkyl and heterocyclic ring; G is selected from the group consisting of: (1) —O—; (2) —N(R¹⁰)—; and (3) —N(R¹⁰R¹¹)—; R⁸—R¹¹ are substituted or unsubstituted radicals independently selected from the group consisting of H, oxygen, linear or branched C₁-C₁₂ alkyls, alkylenes, alkoxys, aryls, alkaryls, aralkyls, cycloalkyls, and heterocyclic rings; provided that any of R⁵, R⁶, R⁷, R⁸—R¹¹ may be joined together with any other of R⁵, R⁶, R⁷, R⁸—R¹¹ to form part of a common ring; any geminal R⁸—R⁹ may combine to form a carbonyl; any vicinal R⁸—R¹¹ may join to form unsaturation; and wherein any one group of substituents R⁸—R¹¹ may combine to form a substituted or unsubstituted fused unsaturated moiety; X is a suitable charge-balancing counterion, in one aspect of Applicant's invention X is a charge-balancing bleach-compatible counterion; and the index v is an integer from 1 to 3.

In another aspect of Applicant's invention the aforementioned iminium cations and polyions have a structure according to Formula II above, wherein R⁵ is H or methyl and R⁶ is H or substituted or unsubstituted, saturated or unsaturated C₁-C₁₄ alkyl.

Suitable iminium cations and polyions include, but are not limited to, N-methyl-3,4-dihydroisoquinolinium tetrafluoroborate, prepared as described in Tetrahedron (1992), 49(2), 423-38 (see, for example, compound 4, p. 433); N-methyl-3,4-dihydroisoquinolinium p-toluene sulfonate, prepared as described in U.S. Pat. No. 5,360,569 (see, for example, Column 11, Example 1); and N-octyl-3,4-dihydroisoquinolinium p-toluene sulfonate, prepared as described in U.S. Pat. No. 5,360,568 (see, for example, Column 10, Example 3).

In one aspect of Applicant's invention, suitable iminium zwitterions include, but are not limited to, iminium zwitterions having a structure according to Formula III below: 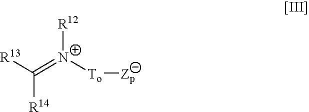
where R¹²—R¹⁴ are independently selected from substituted or unsubstituted radicals selected from the group consisting of H, alkyl, cycloalkyl, aryl, alkaryl, aralkyl, heterocyclic ring, silyl, nitro, halo, cyano, sulfonato, alkoxy, keto, carboxylic, and carboalkoxy radicals; in the formula: 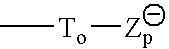
Zₚ⁻ is covalently bonded to Tₒ, and Zₚ⁻ is independently selected from the group consisting of —CO₂⁻, —SO₃⁻, —OSO₃⁻, —SO₂⁻ and —OSO₂⁻ and the index p is 1, 2 or 3; Tₒ is selected from the group consisting of substituted or unsubstituted, linear or branched, saturated or unsaturated alkyl, cycloalkyl, aryl, alkaryl, aralkyl, and heterocyclic ring.

In one aspect of Applicant's invention, the aforementioned iminium zwitterions have the more specific formula depicted by Formula IV below: 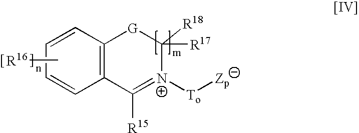
where the index m is 1 to 3 when G is present and m is 1 to 4 when G is not present; and the index n is an integer from 0 to 4; each R¹⁶ is independently selected from a substituted or unsubstituted radical selected from the group consisting of alkyl, cycloalkyl, aryl, fused aryl, heterocyclic ring, fused heterocyclic ring, nitro, halo, cyano, sulfonato, alkoxy, keto, carboxylic, and carboalkoxy radicals, and any two vicinal R¹⁶ substituents may combine to form a fused aryl, fused carbocyclic or fused heterocyclic ring; R¹⁵ may be a substituted or unsubstituted radical selected from the group consisting of H, alkyl, cycloalkyl, alkaryl, aryl, aralkyl, heterocyclic ring, silyl, nitro, halo, cyano, sulfonato, alkoxy, keto, carboxylic, and carboalkoxy radicals; in the formula: 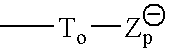
Zₚ⁻ is covalently bonded to Tₒ, and Zₚ⁻ is independently selected from the group consisting of —CO₂⁻, —SO₃⁻, —OSO₃⁻, —SO₂⁻ and —OSO₂⁻ and the index p is 1, 2 or 3; T₀ is selected from the group consisting of: 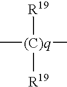
wherein q is an integer from 1 to 8; each R¹⁹ is independently selected from substituted or unsubstituted radicals selected from the group consisting of linear or branched H, alkyl, cycloalkyl, alkaryl, aryl, aralkyl, alkylene, heterocyclic ring, alkoxy, arylcarbonyl, carboxyalkyl and amide groups; G is selected from the group consisting of: (1) —O—; (2) —N(R²⁰)—; and (3) —N(R²⁰R²¹)—; R¹⁷, R¹⁸, R²⁰ and R²¹ are substituted or unsubstituted radicals independently selected from the group consisting of H, oxygen, alkyl, cycloalkyl, alkaryl, aryl, aralkyl, alkylenes, heterocyclic ring, alkoxys, arylcarbonyl groups, carboxyalkyl groups and amide groups; any of R¹⁵, R¹⁶, R¹⁷, R¹⁸, R²⁰ and R²¹ may be joined together with any other of R¹⁵, R¹⁶, R¹⁷, R¹⁸, R²⁰ and R²¹ to form part of a common ring; any geminal R¹⁷—R¹⁸ may combine to form a carbonyl; any vicinal R¹⁷—R²¹ may join to form unsaturation; and wherein any one group of substituents R¹⁷—R²¹ may combine to form a substituted or unsubstituted fused unsaturated moiety.

In another aspect of Applicant's invention the aforementioned iminium zwitterions have a structure according to Formula IV above wherein R¹⁵ is H or methyl, and for the radical represented by the formula: 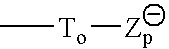
Zₚ⁻ is —CO₂⁻, —SO³⁻ or —OSO₃⁻, and p is 1 or 2, in one aspect of Applicant's invention Zₚ⁻ is —SO₃⁻ or —OSO₃⁻ and p is 1.

Suitable iminium zwitterions include, but are not limited to, N-(3-sulfopropyl)-3,4-dihydroisoquinolinium, inner salt, prepared as described in U.S. Pat. No. 5,576,282 (see, for example, Column 31, Example II); and N-[2-(sulfooxy)dodecyl]-3,4-dihydroisoquinolinium, inner salt, prepared as described in U.S. Pat. No. 5,817,614 (see, for example, Column 32, Example V).

Suitable modified amine oxygen transfer catalysts include, but are not limited to, 1,2,3,4-tetrahydro-2-methyl-1-isoquinolinol, which can be made according to the procedures described in Tetrahedron Letters (1987), 28(48), 6061-6064. Suitable modified amine oxide oxygen transfer catalysts include, but are not limited to, sodium 1-hydroxy-N-oxy-N-[2-(sulfooxy)decyl]-1,2,3,4-tetrahydroisoquinoline. Suitable N-sulfonyl imine oxygen transfer catalysts include, but are not limited to, 3-methyl-1,2-benzisothiazole 1,1-dioxide, prepared according to the procedure described in the Journal of Organic Chemistry (1990), 55(4), 1254-61. Suitable N-phosphonyl imine oxygen transfer catalysts include, but are not limited to, [R-(E)]-N-[(2-chloro-5-nitrophenyl)methylene]-P-phenyl-P-(2,4,6-trimethylphenyl)-phosphinic amide, which can be made according to the procedures described in the Journal of the Chemical Society, Chemical Communications (1994), (22), 2569-70. Suitable N-acyl imine oxygen transfer catalysts include, but are not limited to, [N(E)]-N-(phenylmethylene)acetamide, which can be made according to the procedures described in Polish Journal of Chemistry (2003), 77(5), 577-590. Suitable thiadiazole dioxide oxygen transfer catalysts include but are not limited to, 3-methyl4-phenyl-1,2,5-thiadiazole 1,1-dioxide, which can be made according to the procedures described in U.S. Pat. No. 5,753,599 (Column 9, Example 2). Suitable perfluoroimine oxygen transfer catalysts include, but are not limited to, (Z)-2,2,3,3,4,4,4-heptafluoro-N-(nonafluorobutyl)butanimidoyl fluoride, which can be made according to the procedures described in Tetrahedron Letters (1994), 35(34), 6329-30.

Applicant's organic catalyst systems may consist solely of suitable oxygen transfer catalysts, bleach activators and a source of hydrogen peroxide or such systems may comprise optional ingredients such as fillers. Such organic catalyst systems typically comprise a sufficient amount of oxygen transfer catalyst, bleach activator and source of hydrogen peroxide such that the weight ratio of oxygen transfer catalyst to bleach activator is from about 1:5 to about 1:1000, or from about 1:10 to about 1:500, and the weight ratio of bleach activator to source of hydrogen peroxide is from about 3:1 to about 1:10 or from about 2:1 to about 1:5.

The organic catalyst systems described herein may be employed as a laundry additive; aforementioned improved bleaching performance may also be obtained from formulated cleaning compositions comprising such systems.

Cleaning Compositions

The cleaning composition of the present invention may be advantageously employed for example, in laundry applications, hard surface cleaning, automatic dishwashing applications, as well as cosmetic applications such as dentures, teeth, hair and skin. Furthermore, the organic catalyst systems of the present invention may be employed in both granular and liquid compositions.

Applicants' cleaning compositions comprise an effective amount of suitable oxygen transfer catalyst, bleach activator and source of hydrogen peroxide. The required level of such materials may be achieved by combining the respective components of Applicant's organic catalyst system with suitable detergent adjuncts. As a practical matter, and not by way of limitation, the compositions and cleaning processes herein can be adjusted to provide on the order of from about 2 ppm to about 2000 ppm of the source of hydrogen peroxide, from about 5 ppm to about 500 ppm of bleach activator and from about 0.05 to about 15 ppm of oxygen transfer catalyst in the wash liquor.

In order to obtain the aforementioned levels in the wash liquor, the cleaning compositions of the present invention will typically comprise from about 0.0002% to about 5%, or from about 0.001% to about 1.5%, of oxygen transfer catalyst, by weight of the cleaning composition. The source of hydrogen peroxide will typically comprise from about 0.5% to about 70%, from about 30 1% to about 70%, or from about 1% to about 50% by weight of the cleaning composition. Bleach activators will typically comprise from about 0.1% to about 60%, from about 0.5% to about 60%, or from about 0.5% to about 40% by weight of the cleaning composition.

The cleaning compositions herein may be formulated such that, during use in aqueous cleaning operations, the wash water will have a pH of between about 6.5 and about 11, in one aspect of Applicant's invention, the cleaning compositions herein may be formulated such that, during use in aqueous cleaning operations, the wash water will have a pH of between about 7.5 and 10.5. Liquid dishwashing product formulations may have a pH between about 6.8 and about 9.0. Laundry products may have a pH of from about 8 to about 11. Techniques for controlling pH at recommended usage levels include the use of buffers, alkalis, acids, etc., and are well known to those skilled in the art.

Adjunct Materials

While not essential for the purposes of the present invention, the non-limiting list of adjuncts illustrated hereinafter are suitable for use in the instant cleaning compositions and may be desirably incorporated in preferred embodiments of the invention, for example to assist or enhance cleaning performance, for treatment of the substrate to be cleaned, or to modify the aesthetics of the cleaning composition as is the case with perfumes, colorants, dyes or the like. The precise nature of these additional components, and levels of incorporation thereof, will depend on the physical form of the composition and the nature of the cleaning operation for which it is to be used. Suitable adjunct materials include, but are not limited to, surfactants, builders, chelating agents, dye transfer inhibiting agents, dispersants, enzymes, and enzyme stabilizers, catalytic metal complexes, polymeric dispersing agents, clay soil removal/anti-redeposition agents, brighteners, suds suppressors, dyes, perfumes, structure elasticizing agents, fabric softeners, carriers, hydrotropes, processing aids and/or pigments. In addition to the disclosure below, suitable examples of such other adjuncts and levels of use are found in U.S. Pats. Nos. 5,576,282, 6,306,812 B1 and 6,326,348 B1 that are incorporated by reference.

As stated, the adjunct ingredients are not essential to Applicants' cleaning and fabric care compositions. Thus, certain embodiments of Applicants' cleaning compositions do not contain one or more of the following adjuncts materials: surfactants, builders, chelating agents, dye transfer inhibiting agents, dispersants, enzymes, and enzyme stabilizers, catalytic metal complexes, polymeric dispersing agents, clay soil removal/anti-redeposition agents, brighteners, suds suppressors, dyes, perfumes, structure elasticizing agents, fabric softeners, carriers, hydrotropes, processing aids and/or pigments. However, when one or more adjuncts is present, such one or more adjuncts may be present as detailed below:

Surfactants—Preferably, the cleaning compositions according to the present invention comprise a surfactant or surfactant system wherein the surfactant can be selected from nonionic and/or anionic and/or cationic surfactants and/or amphoteric and/or zwitterionic and/or semi-polar nonionic surfactants.

The surfactant is typically present at a level of from about 0.1%, preferably about 1%, more preferably about 5% by weight of the cleaning compositions to about 99.9%, preferably about 80%, more preferably about 35%, most preferably about 30% by weight of the cleaning compositions.

Builders—The cleaning compositions of the present invention preferably comprise one or more detergent builders or builder systems. When present, the compositions will typically comprise at least about 1% builder, preferably from about 5%, more preferably from about 10% to about 80%, preferably to about 50%, more preferably to about 30% by weight, of detergent builder.

Builders include, but are not limited to, the alkali metal, ammonium and alkanolammonium salts of polyphosphates, alkali metal silicates, alkaline earth and alkali metal carbonates, aluminosilicate builders polycarboxylate compounds. ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Chelating Agents—The cleaning compositions herein may also optionally contain one or more copper, iron and/or manganese chelating agents.

If utilized, these chelating agents will generally comprise from about 0.1% by weight of the cleaning compositions herein to about 15%, more preferably 3.0% by weight of the cleaning compositions herein.

Dye Transfer Inhibiting Agents—The cleaning compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof.

When present in the cleaning compositions herein, the dye transfer inhibiting agents are present at levels from about 0.0001%, more preferably about 0.01%, most preferably about 0.05% by weight of the cleaning compositions to about 10%, more preferably about 2%, most preferably about 1% by weight of the cleaning compositions.

Dispersants—The cleaning compositions of the present invention can also contain dispersants. Suitable water-soluble organic materials are the homo- or co-polymeric acids or their salts, in which the polycarboxylic acid comprises at least two carboxyl radicals separated from each other by not more than two carbon atoms.

Enzymes—The cleaning compositions can comprise one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and known amylases, or mixtures thereof. A preferred combination is a cleaning composition having a cocktail of conventional applicable enzymes like protease, lipase, cutinase and/or cellulase in conjunction with amylase.

Enzyme Stabilizers—Enzymes for use in detergents can be stabilized by various techniques. The enzymes employed herein can be stabilized by the presence of water-soluble sources of calcium and/or magnesium ions in the finished compositions that provide such ions to the enzymes.

Catalytic Metal Complexes—Applicants' cleaning compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra (methylenephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pats. Nos. 5,597,936 and 5,595,967. Such cobalt catalysts are readily prepared by known procedures, such as taught for example in U.S. Pats. Nos. 5,597,936, and 5,595,967.

Compositions herein may also suitably include a transition metal complex of a macropolycyclic rigid ligand—abbreviated as “MRL”. As a practical matter, and not by way of limitation, the compositions and cleaning processes herein can be adjusted to provide on the order of at least one part per hundred million of the active MRL species in the aqueous washing medium, and will preferably provide from about 0.005 ppm to about 25 ppm, more preferably from about 0.05 ppm to about 10 ppm, and most preferably from about 0.1 ppm to about 5 ppm, of the MRL in the wash liquor.

Preferred transition-metals in the instant transition-metal bleach catalyst include manganese, iron and chromium. Preferred MRL's herein are a special type of ultra-rigid ligand that is cross-bridged such as 5,12-diethyl-1,5,8,12-tetraazabicyclo[6.6.2]hexadecane.

Suitable transition metal MRLs are readily prepared by known procedures, such as taught for example in WO 00/332601, and U.S. Pat. No. 6,225,464.

Processes of Making and Using of Applicants' Cleaning Composition

The cleaning compositions of the present invention can be formulated into any suitable form and prepared by any process chosen by the formulator, non-limiting examples of which are described in U.S. Pat. Nos. 5,879,584; 5,691,297; 5,574,005; 5,569,645; 5,565,422; 5,516,448; 5,489,392; and 5,486,303 all of which are incorporated herein by reference.

Method of Use

The present invention includes a method for cleaning a situs inter alia a surface or fabric. Such method includes the steps of contacting an embodiment of Applicants' cleaning composition, in neat form or diluted in a wash liquor, with at least a portion of a surface or fabric then rinsing such surface or fabric. The surface or fabric may be subjected to a washing step prior to the aforementioned rinsing step. For purposes of the present invention, washing includes but is not limited to, scrubbing, and mechanical agitation. As will be appreciated by one skilled in the art, the cleaning compositions of the present invention are ideally suited for use in laundry applications. Accordingly, the present invention includes a method for laundering a fabric. The method comprises the steps of contacting a fabric to be laundered with a said cleaning laundry solution comprising at least one embodiment of Applicants cleaning composition, cleaning additive or mixture thereof. The fabric may comprise most any fabric capable of being laundered in normal consumer use conditions. The solution may have a pH of from about 8 to about 10.5. The compositions may be employed at concentrations of from about 500 ppm to about 15,000 ppm in solution. The water temperatures may range from about 5° C. to about 90° C. The water to fabric ratio can be from about 1:1 to about 30:1.

### EXAMPLES

### Example 1

### Preparation of sodium 1-hydroxy-N-oxy-N-[2-(sulfooxy)decyl]-1,2,3,4-tetrahydroisoquinoline:

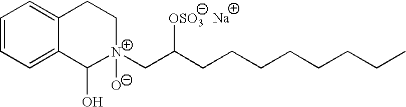

A 1 L round bottom flask equipped with magnetic stir bar is charged with N-[2-(sulfooxy)decyl]-3,4-dihydroisoquinolinium, inner salt (36.7 g, 0.10 mol; prepared according to U.S. Pat. No. 5,817,614, Column 29, Example 1) and water (500 mL). To the aqueous solution is added a sufficient quantity of 10% sodium hydroxide solution so as to achieve a pH of 12. The solution is stirred at room temperature for 1 h. To the flask is added a solution of 30% hydrogen peroxide solution (1.1 equiv), and the solution is stirred for 30 min, yielding an aqueous solution of the modified amine oxide compound.

### Example 2

A laundry detergent composition suitable for machine use is prepared by standard methods and comprises the following composition:

Weight %

| Component | Formula A | Formula B |
|---|---|---|
| Oxygen transfer catalyst¹ | 0.1 | 0.04 |
| LOBS² | 4.00 | 5.20 |
| Sodium Percarbonate | 9.2 | 8.0 |
| Sodium Carbonate | 23.74 | 21.0 |
| Anionic surfactant | 14.80 | 12.0 |
| Alumino Silicate | 21.30 | 18.0 |
| Silicate | 1.85 | 0.00 |
| Diethylenetriaminepentacetic acid | 0.43 | 0.3 |
| Nonionic surfactant | 0.00 | 0.5 |
| Polyacrylic acid | 2.72 | 2.0 |
| Brightener | 0.23 | 0.3 |
| Polyethylene glycol solids | 1.05 | 0.00 |
| Sulfate | 8.21 | 17.0 |
| Perfume | 0.25 | 0.25 |
| Water | 7.72 | 6.7 |
| Processing aid | Balance | Balance |
| | to 100% | to 100% |

¹Any suitable oxygen transfer catalyst according to the present invention (e.g., N-methyl-3,4-dihydroisoquinolinium p-toluene sulfonate)
²Sodium 4-(lauroyloxy)benzenesulfonate

The composition is used to launder fabrics at a concentration in solution of about 1000 ppm at a temperature of 5-40° C. and a water to fabric ratio of about 20:1.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A composition comprising:
a.) a source of hydrogen peroxide;
b.) a bleach activator having the general formula: 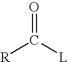
wherein R is a substituted or unsubstituted, linear or branched hydrocarbyl group containing from about 10 to about 18 carbon atoms wherein the longest linear alkyl chain extending from and including the carbonyl carbon contains greater than 10 carbon atoms and L is a leaving group, the conjugate acid of which has a pKₐ in the range of from about 4 to about 18; and
c.) an oxygen transfer catalyst selected from the group consisting of:
(i) iminium cations and polyions;
(ii) iminium zwitterions;
(iii) modified amines;
(iv) modified amine oxides;
(v) N-sulfonyl imines;
(vi) N-phosphonyl imines;
(vii) N-acyl imines;
(viii) thiadiazole dioxides;
(ix) perfluoroimines; and
(x) mixtures thereof.

2. The composition of claim 1 wherein said oxygen transfer catalyst is selected from the group consisting of iminium cations and polyions, iminium zwitterions and mixtures thereof.

3. The composition of claim 1 wherein for said bleach activator, L is a leaving group, the conjugate acid of which has a pKₐ in the range of from about 6 to about 13.

4. The composition of claim 3 wherein said bleach activator's leaving group L has the formula: 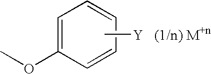
wherein Y is selected from the group consisting of —SO₃⁻ and —CO₂⁻ and M is selected from H, Li, Na, K, Mg and Ca, and n is 1 or 2.

5. The composition of claim 1, said composition having a weight ratio of oxygen transfer catalyst to bleach activator of from about 1:5 to about 1:1000 and a weight ratio of bleach activator to source of hydrogen peroxide of from about 3:1 to about 1:10.

6. The composition of claim 5, said composition having a weight ratio of oxygen transfer catalyst to bleach activator of from about 1:10 to about 1:500 and a weight ratio of bleach activator to source of hydrogen peroxide of from about 2:1 to about 1:5.

7. The composition of claim 5, said composition comprising, based on total composition weight, from about 0.0002% to about 5% of said oxygen transfer catalyst, from about 0.5% to about 70% of said source of hydrogen peroxide, and from about 0.1% to about 60% of said bleach activator.

8. The composition of claim 7, said composition comprising based on total composition weight, from about 0.0001% to about 1.5% of said oxygen transfer catalyst, from about 1% to about 70% of said source of hydrogen peroxide, and from about 0.5% to about 60% of said bleach activator.

9. The composition of claim 8, said composition comprising based on total composition weight, from about 1% to about 50% of said source of hydrogen peroxide, and from about 0.5% to about 40% of said bleach activator.
